(19) United States
(12) Patent Application Publication
(10) Pub. No.: US 2012/0230299 A1
(43) Pub. Date: Sep. 13, 2012

(54) Method for Reconfiguring Micro Base Station and Corresponding Micro Base Station

(75) Inventors: Guiming Shu, Shenzhen (CN); Zhiming Ding, Shenzhen (CN); Yongli Yang, Shenzhen (CN)

(73) Assignee: HUAWEI DEVICE CO., LTD., Shenzhen (CN)

(21) Appl. No.: 13/482,530

(22) Filed: May 29, 2012

Related U.S. Application Data
(63) Continuation of application No. PCT/CN2010/074557, filed on Jun. 26, 2010.

(30) Foreign Application Priority Data
Nov. 27, 2009 (CN) 200910226264.8

(51) Int. Cl. H04W 72/04; H04W 36/24

(52) U.S. Cl. 370/331; 370/329

(57) ABSTRACT

Embodiments of the present invention disclose a method for reconfiguring a micro base station and a corresponding micro base station to solve a radio frequency conflict of the micro base station, so that a radio frequency conflict can be solved, and meanwhile, service continuity on a currently served wireless terminal can be ensured. The provided method for reconfiguring a micro base station includes: obtaining a reconfiguration parameter of a radio frequency; sending an indication message to a wireless terminal that is served, where the indication message carries an identifier of the micro base station and a radio frequency parameter that is to be used after reconfiguration, or, the indication message carries an identifier of a neighboring base station of the micro base station and a radio frequency parameter that is used by the neighboring base station; and performing radio frequency reconfiguration according to the reconfiguration parameter of the radio frequency.

### CROSS-REFERENCE TO RELATED APPLICATIONS

This application is a continuation of International Application No. PCT/CN2010/074557, filed on Jun. 26, 2010, which claims priority to Chinese Patent Application No. 200910226264.8, filed on Nov. 27, 2009, all of which are hereby incorporated by reference in their entireties.

### FIELD OF THE INVENTION

The present invention relates to the field of communications technologies, and in particular, to a method for reconfiguring a micro base station and a corresponding micro base station, so as to solve a radio frequency conflict of the micro base station.

### BACKGROUND OF THE INVENTION

As a supplement of a macro cellular network, more and more operators start to deploy micro base station networks of their own. With respect to deployment manners and site features of micro base stations, usually, the micro base stations are uniformly managed by a micro base station operator. Due to a dynamic change of a wireless signal in an environment, a radio frequency conflict may occur on a micro base station that works normally. At this time, the micro base station operator can remotely reconfigure a radio frequency parameter for the micro base station through a management functional entity of the micro base station, so as to solve the radio frequency conflict.

In an implementation process of the present invention, the inventor researches and finds that the prior art has at least the following problems:

Currently, when radio frequency reconfiguration is performed on a micro base station, a method that is usually adopted is to directly interrupt a current communication service, however, service continuity on a wireless terminal that is currently served is not considered.

### SUMMARY OF THE INVENTION

Embodiments of the present invention provide a method for reconfiguring a micro base station and a corresponding micro base station, so that a radio frequency conflict can be solved, and meanwhile, service continuity on a wireless terminal that is currently served can be ensured.

An embodiment of the present invention provides a method for reconfiguring a micro base station, where the method includes the following content:

obtaining a reconfiguration parameter of a radio frequency;

sending an indication message to a wireless terminal that is served, where the indication message carries an identifier of the micro base station and a radio frequency parameter that is to be used after reconfiguration, or, the indication message carries an identifier of a neighboring base station of the micro base station and a radio frequency parameter that is used by the neighboring base station; and

performing radio frequency reconfiguration according to the reconfiguration parameter of the radio frequency.

An embodiment of the present invention provides another method for reconfiguring a micro base station, where the method includes the following content:

obtaining a reconfiguration parameter of a radio frequency by using a first carrier frequency;

configuring the reconfiguration parameter of the radio frequency on a second carrier frequency and enabling the second carrier frequency; and

sending an indication message by using the first carrier frequency to a wireless terminal that is served, where the indication message carries an identifier of the micro base station and a radio frequency parameter that is to be used by the second carrier frequency.

Based on the foregoing two method embodiments, an embodiment of the present invention provides a micro base station, including:

a reconfiguration parameter obtaining unit, configured to obtain a reconfiguration parameter of a radio frequency;

an indication message sending unit, configured to send an indication message to a wireless terminal that is served, where the indication message carries an identifier of the micro base station and a radio frequency parameter that is to be used after reconfiguration, or, the indication message carries an identifier of a neighboring base station of the micro base station and a radio frequency parameter that is used by the neighboring base station; and

a reconfiguration unit, configured to perform radio frequency reconfiguration according to the reconfiguration parameter of the radio frequency.

An embodiment of the present invention provides another micro base station, including:

a reconfiguration parameter obtaining unit, configured to obtain a reconfiguration parameter of a radio frequency by using a first carrier frequency;

a reconfiguration unit, configured to perform configuration on the reconfiguration parameter of the radio frequency on a second carrier frequency and enable the second carrier frequency; and

an indication message sending unit, configured to send an indication message by using the first carrier frequency to a wireless terminal that is served, where the indication message carries an identifier of the micro base station and a radio frequency parameter that is to be used by the second carrier frequency.

It can be known from the technical solution of each foregoing embodiment of the present invention that, after obtaining the reconfiguration parameter of the radio frequency, the micro base station either first sends the indication message to the wireless terminal that is currently served to instruct the wireless terminal that is currently served to initiate a handover to the micro base station itself or to a neighboring base station, and then performs radio frequency reconfiguration according to the reconfiguration parameter of the radio frequency; or first configures the reconfiguration parameter on the second carrier frequency and enables the second carrier frequency, and then sends the indication message by using the first carrier frequency to the wireless terminal that is served to instruct the wireless terminal that is currently served to initiate a handover to the second carrier frequency of the micro base station itself. Through such a process, the micro base station completes the radio frequency reconfiguration, so that a problem of a radio frequency conflict is solved. At the same time, there is only a delay of no more than one base-station-to-base-station handover for a service on the wireless terminal that is currently served, thereby ensuring continuity of a current service.

### BRIEF DESCRIPTION OF THE DRAWINGS

To describe the technical solutions in the embodiments of the present invention more clearly, the accompanying drawings required for describing the embodiments are introduced briefly in the following. Apparently, the accompanying drawings in the following description are only some embodiments of the present invention, and persons of ordinary skills in the art may still derive other drawings from these accompanying drawings without creative efforts.

FIG. 1 is a flow chart of a method for reconfiguring a micro base station according to an embodiment of the present invention;

FIG. 2 is a diagram of message interaction in a process of solving a radio frequency conflict of the micro base station in FIG. 1;

FIG. 3 is a flow chart of another method for reconfiguring a micro base station according to an embodiment of the present invention;

FIG. 4 is a diagram of message interaction in a process of solving a radio frequency conflict of the micro base station in FIG. 3;

FIG. 5 is a composition diagram of functional units of a micro base station according to an embodiment of the present invention; and

FIG. 6 is a composition diagram of functional units of another micro base station according to an embodiment of the present invention.

### DETAILED DESCRIPTION OF THE EMBODIMENTS

In order to make the objectives, technical solutions, and advantages of the present invention clearer, the technical solutions provided in the embodiments of the present invention are further described in detail in the following with reference to the accompanying drawings and the embodiments.

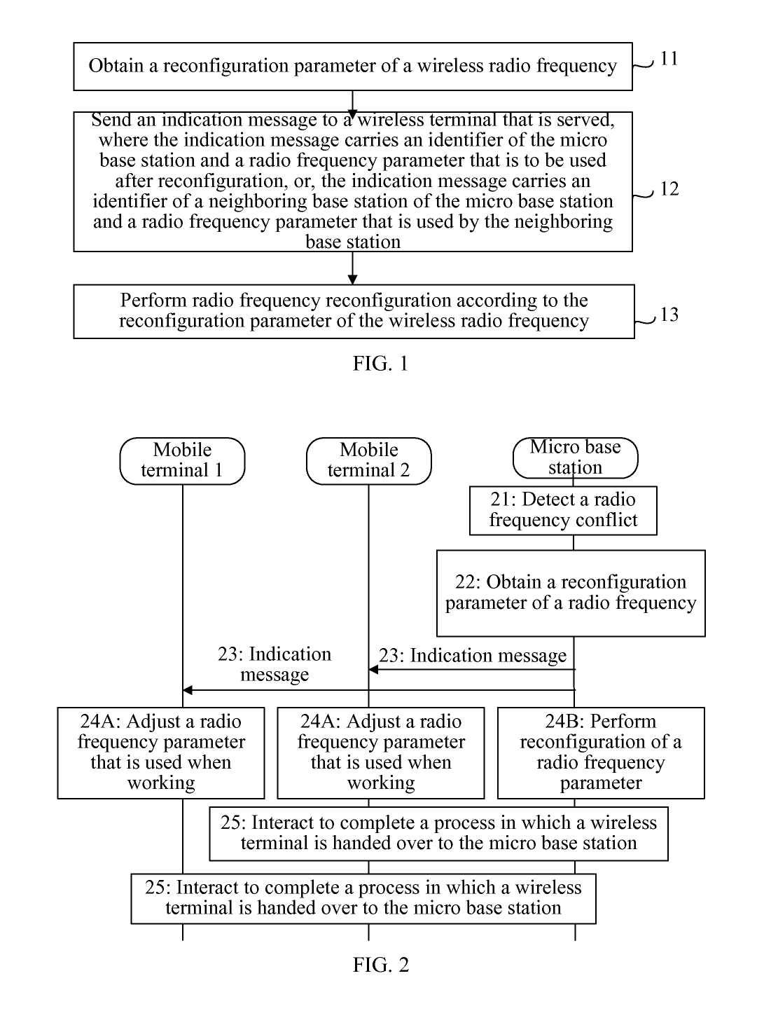

Referring to FIG. 1, an embodiment of the present invention provides a method for reconfiguring a micro base station, where the method includes the following content:

11: Obtain a reconfiguration parameter of a radio frequency.

When providing an access service for a wireless terminal, a micro base station in a normal working state also detects a peripheral wireless environment at the same time. When the micro base station detects that a conflict exists between a peripheral wireless signal and a radio frequency that is used by an air interface of the micro base station,

in one manner, a management functional entity of the micro base station uniformly allocates and manages a radio frequency used by each micro base station. In this manner, after detecting a radio frequency conflict, the micro base station reports radio frequency conflict information to the management functional entity and requests the management functional entity to perform reconfiguration for the radio frequency. The reported radio frequency conflict information includes, but is not limited to, frequencies and strengths of wireless signals between which a conflict occurs, and a period of wireless signals between which the conflict occurs. If the radio frequency conflict is caused by a peripheral base station, the conflict information needs to further include information such as an identifier of the base station, a central frequency of an uplink channel and a central frequency of a downlink channel. Based on the reported radio frequency conflict information and according to a deployment condition and a radio frequency using condition of an access point on the periphery of the micro base station that reports the radio frequency conflict, the management functional entity of the micro base station makes a comprehensive analysis on a peripheral wireless environment to determine a new reconfiguration parameter of the radio frequency for the micro base station that reports the radio frequency conflict and deliver the new reconfiguration parameter to the micro base station; and

in another manner, the micro base station selects by itself to determine a reconfiguration parameter of the radio frequency. At this time, after detecting a radio frequency conflict, the micro base station no longer needs to obtain a reconfiguration parameter from the management functional entity of the micro base station, but makes an analysis by itself on the peripheral wireless environment according to detected radio frequency conflict information and radio frequency information that is used by a peripheral macro base station or a peripheral micro base station, and determines a reconfiguration parameter of the radio frequency according to information of a wireless frequency spectrum fragment of an area where the micro base station itself is located (information of a wireless frequency spectrum fragment that is allocated by an operator to the area). In order to obtain the radio frequency information that is used by the peripheral macro base station or the peripheral micro base station, the micro base station may adopt a method for preconfiguring the radio frequency information (the radio frequency information needs to be updated synchronously when a change occurs) on the micro base station, where the radio frequency information is used by the peripheral macro base station or the peripheral micro base station, or the micro base station obtains the radio frequency information by scanning the peripheral macro base station or the peripheral micro base station or obtains the radio frequency information through neighboring base station information that is shared between access points (base stations).

The reconfiguration parameter of the radio frequency include, but are not limited to, a characteristic of an independent uplink channel at a physical layer, where the characteristic of the independent uplink channel at the physical layer is defined in IEEE 802.16-2009 (Table 568, IEEE 802.16-2009), characteristics of uplink and downlink channels of the orthogonal frequency division multiple access (Orthogonal Frequency Division Multiple Access, OFDMA) (Table 571, 575, IEEE 802.16-2009), and central frequencies, transmitting power and preamble sequences of the uplink and downlink channels, and so on, where the reconfiguration parameter of the radio frequency is obtained by the micro base station.

In addition, in a scenario where the micro base station works normally without a radio frequency conflict, the micro base station operator may also actively deliver a new reconfiguration parameter to the micro base station through the management functional entity of the micro base station according to an operating policy, for example, replanning frequency spectrums used by micro base stations in different areas. After the micro base station receives the reconfiguration parameter that is actively delivered by the management functional entity of the micro base station, the micro base station also needs to perform a reconfiguration process.

12: Send an indication message to a wireless terminal that is served, where the indication message carries an identifier of the micro base station and a radio frequency parameter that is to be used after reconfiguration, or, the indication message carries an identifier of a neighboring base station of the micro base station and a radio frequency parameter that is used by the neighboring base station.

After obtaining the reconfiguration parameter of the radio frequency, the micro base station performs a radio frequency reconfiguration process. However, in order to maintain service continuity on the wireless terminal that is currently connected to the micro base station (performing communication through the current micro base station), before performing the radio frequency reconfiguration, the micro base station may send a handover request message in advance to the wireless terminal that is currently served. The handover request message includes the identifier of the micro base station and a predetermined radio frequency parameter that is to be used after reconfiguration and when communication is performed with the wireless terminal that is served. The radio frequency parameter includes a preamble sequence, a channel parameter, and so on. Meanwhile, in order to speed up a process in which the wireless terminal is handed over to the micro base station after reconfiguration, the message may further include a wireless channel parameter that is predetermined by the micro base station and to be used when communication is performed with the wireless terminal after reconfiguration, for example, information needed in a handover of the wireless terminal, such as preamble sequence information, sub-channel information, and so on.

Alternatively, apart from actively initiating a handover to the wireless terminal by using a handover message, the micro base station may also send a broadcast message (such as a neighboring broadcast message or a downlink channel description message, and so on) before reconfiguration to the wireless terminal that is served. The broadcast message carries the same information as that in the foregoing handover request message, for example, the identifier of the micro base station and a predetermined radio frequency parameter that is to be used after reconfiguration and when communication is performed with the wireless terminal that is served. Meanwhile, in order to speed up a process in which the wireless terminal is handed over to the micro base station after reconfiguration, the message may further include a wireless channel parameter that is predetermined by the micro base station and to be used when communication is performed with the wireless terminal after reconfiguration, for example, information needed in a handover of the wireless terminal, such as preamble sequence information, sub-channel information, and so on. After receiving the broadcast message, the wireless terminal may actively initiate a handover request to the micro base station, and complete a handover process through message interaction with the micro base station.

The foregoing description is a scenario that, after completing reconfiguration, a serving micro base station enables the wireless terminal to be handed over to the serving micro base station itself. In addition, the serving micro base station may also carry an identifier of a neighboring base station of the serving micro base station and a radio frequency parameter that is used by the neighboring base station, such as a preamble sequence or a channel frequency, and so on, in an indication message (a handover request message or a broadcast message) that is sent to the wireless terminal that is served, where the neighboring base station of the serving micro base station includes a macro base station or a micro base station, where the macro base station or the micro base station is adjacent to the serving micro base station. Especially, a serving micro base station after being reconfigured with a wireless parameter may also be logically used as a neighboring base station of the serving micro base station before being reconfigured with a wireless parameter, and they are physically the same micro base station, but only a wireless parameter that is used before and after the reconfiguration are different. After receiving the indication message, the wireless terminal may initiate a handover process to the neighboring base station according to the carried identifier of the neighboring base station and information of a used radio frequency parameter. At the same time, the service continuity on the wireless terminal that is currently served may be ensured through such a handover process.

It should be noted that, in order to carry the identifier of the neighboring base station of the serving micro base station and the used radio frequency parameter in the handover request message or the broadcast message, where the handover request message or the broadcast message is sent to the wireless terminal that is served, the serving micro base station needs to obtain the identifier of its neighboring base station and the used radio frequency parameter before sending the handover request message or the broadcast message to the wireless terminal that is served, where the neighboring base station of the serving micro base station includes a macro base station or a micro base station, where the macro base station or the micro base station is adjacent to the serving micro base station.

The serving micro base station may adopt the following methods to obtain the identifier of its neighboring base station and the used radio frequency parameter. In a first manner, when a micro base station is deployed, information of an identifier of its neighboring base station and information of a radio frequency parameter that is used by the neighboring base station may be preconfigured on the micro base station. When the serving micro base station needs the information, the serving micro base station may obtain the information through local query. In a second manner, information of identifiers of base stations and information of a radio frequency parameter that is used by the base stations in a whole network of a certain area may be uniformly managed by a base station management server (or an information management server). When the serving micro base station needs the information, the serving micro base station makes a request to the base station management server (or the information management server) for querying and obtaining the information. After receiving a query request from the serving micro base station, the base station management server (or the information management server) sends information of an identifier of a neighboring base station of the serving micro base station and information of a radio frequency parameter that is used by the neighboring base station to the serving micro base station by querying a corresponding message.

13: Perform radio frequency reconfiguration according to the reconfiguration parameter of the radio frequency.

After receiving the foregoing indication message (the handover request message or the broadcast message), the wireless terminal adjusts, according to the indication message, a radio frequency parameter that is used when the wireless terminal works. Meanwhile, the micro base station itself performs a reconfiguration process of the radio frequency according to the reconfiguration parameter of the radio frequency.

Moreover, after completing the radio frequency reconfiguration according to the reconfiguration parameter of the radio frequency, the micro base station further interacts with the wireless terminal that is served to complete a process in which the wireless terminal is handed over to the micro base station or to the neighboring base station of the micro base station.

For a process in which the wireless terminal after radio frequency parameter adjustment is handed over to the micro base station or to the neighboring base station of the micro base station, reference may be made to a mechanism that a terminal is handed over between two base stations, where the mechanism is defined in an existing regulation of the worldwide interoperability for microwave access (Worldwide Interoperability for Microwave Access, WiMAX). It should be noted that, when the wireless terminal is handed over to the micro base station, a source base station and a target base station to which the wireless terminal is handed over are the same physical micro base station at this time. However, a radio frequency and some channel parameters are changed before and after the handover, where the radio frequency and some channel parameters are used by the micro base station.

Referring to FIG. 2, FIG. 2 is a diagram of message interaction in a process of solving a radio frequency conflict of a micro base station in this embodiment. The message interaction includes the following steps:

21: A micro base station detects a radio frequency conflict.

22: The micro base station obtains a reconfiguration parameter of a radio frequency.

23: The micro base station sends an indication message to a wireless terminal that is currently served, where the indication message carries an identifier of the micro base station and a radio frequency parameter that is to be used after reconfiguration.

The indication message may be a handover request message or a broadcast message, and the radio frequency parameter includes a preamble sequence and a channel parameter.

24A: The wireless terminal adjusts, according to the indication message, a radio frequency parameter used when the wireless terminal works.

24B: At the same time with step 24A, the micro base station performs radio frequency reconfiguration according to the reconfiguration parameter.

25: The micro base station interacts with the wireless terminal to complete a process in which the wireless terminal is handed over to the micro base station.

By adopting the micro base station reconfiguration method provided in this embodiment, after obtaining the reconfiguration parameter of the radio frequency, the micro base station first sends the indication message to the wireless terminal that is currently served to instruct the wireless terminal that is currently served to initiate a handover to the micro base station itself or to a neighboring base station of the micro base station, and then the micro base station maintains context information of the wireless terminal and performs radio frequency reconfiguration. Through such a process, the micro base station completes the radio frequency reconfiguration, so that a problem of a radio frequency conflict is solved. At the same time, there is only a delay of no more than one base-station-to-base-station handover for a service on the wireless terminal that is currently served, thereby ensuring continuity of a current service.

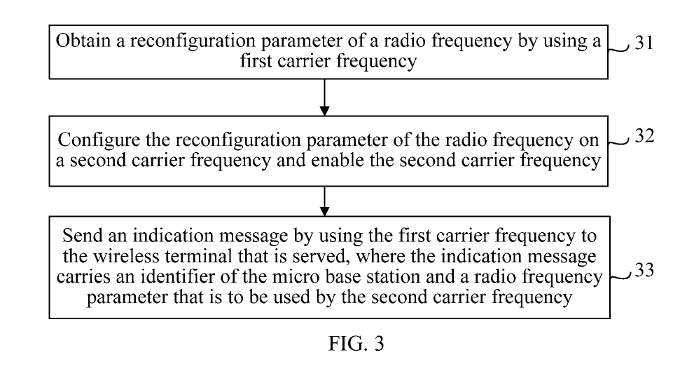

Referring to FIG. 3, an embodiment of the present invention provides another method for reconfiguring a micro base station, where the method includes the following content:

31: Obtain a reconfiguration parameter of a radio frequency by using a first carrier frequency.

The micro base station in this embodiment can provide a dual-carrier-frequency function. The micro base station can work with two different frequencies at different time alternately or at the same time. The micro base station uses a single-carrier-frequency mode when working normally, for example, uses the first carrier frequency to provide a communication service for a wireless terminal. When the micro base station obtains the reconfiguration parameter of the radio frequency by using the first carrier frequency, a process of radio frequency reconfiguration is performed. The micro base station in this embodiment may also obtain the reconfiguration parameter through any one of the following manners.

In a first manner, when detecting a radio frequency conflict, the micro base station sends a request of radio frequency reconfiguration to a management functional entity of the micro base station by using the first carrier frequency. The request of radio frequency reconfiguration carries information of a detected radio frequency conflict. The first carrier frequency of the micro base station receives a reconfiguration parameter of the radio frequency, where the reconfiguration parameter of the radio frequency are delivered, based on the information of the radio frequency conflict, by the management functional entity of the micro base station.

In a second manner, when detecting a radio frequency conflict, the micro base station makes an analysis on a peripheral wireless environment by using the first carrier frequency according to information of a detected radio frequency conflict and information of a radio frequency that is used by a peripheral macro base station or a peripheral micro base station, and determines a reconfiguration parameter of the radio frequency according to information of a wireless frequency spectrum fragment of an area where the micro base station itself is located.

In a third manner, the micro base station that works normally receives a reconfiguration parameter that is actively delivered by the management functional entity of the micro base station to the micro base station.

32: Configure the reconfiguration parameter of the radio frequency on a second carrier frequency and enable the second carrier frequency.

After obtaining a new reconfiguration parameter of the radio frequency, the micro base station configures the new reconfiguration parameter of the radio frequency on the second carrier frequency and enables the second carrier frequency. In this way, the first carrier frequency and the second carrier frequency of the micro base station are in a state of working at different time alternately or at the same time.

33: Send an indication message by using the first carrier frequency to the wireless terminal that is served, where the indication message carries an identifier of the micro base station and a radio frequency parameter that is to be used by the second carrier frequency.

In order to maintain service continuity on the wireless terminal that is currently served, after performing radio frequency reconfiguration, the micro base station needs to send an indication message in time to the wireless terminal that is currently served. The indication message may be a handover request message or a broadcast message (such as a neighboring broadcast message or a downlink channel description message, and so on). The indication message carries the identifier of the micro base station and the radio frequency parameter that is to be used by the second carrier frequency, and the radio frequency parameter includes a preamble sequence, a channel parameter, and so on, to instruct the wireless terminal that is currently served to initiate a handover to the micro base station itself Meanwhile, in order to speed up a process in which the wireless terminal is handed over to the micro base station after reconfiguration, the message may further include a wireless channel parameter that is predetermined by the micro base station and to be used when communication is performed with the wireless terminal after reconfiguration, for example, information needed in a handover of the wireless terminal, such as preamble sequence information, sub-channel information, and so on.

It should be noted that, before the handover, the micro base station still needs to send the foregoing indication message through the first carrier frequency to the wireless terminal that is currently served. After sending the indication message by using the first carrier frequency to the wireless terminal that is served, the micro base station interacts with the wireless terminal that is served to complete a process in which the wireless terminal is handed over to the second carrier frequency of the micro base station.

After receiving the foregoing indication message, the wireless terminal adjusts, according to the indication message, a radio frequency parameter that is used when the terminal works, and performs the process in which the wireless terminal is handed over to the second carrier frequency of the micro base station. For a detailed handover process, reference may be made to a mechanism that a terminal is handed over between two base stations, where the mechanism is defined in an existing regulation of the WiMAX, which is not described here again.

After the handover is completed, the micro base station works at a reconfigured second carrier frequency, and closes the first carrier frequency.

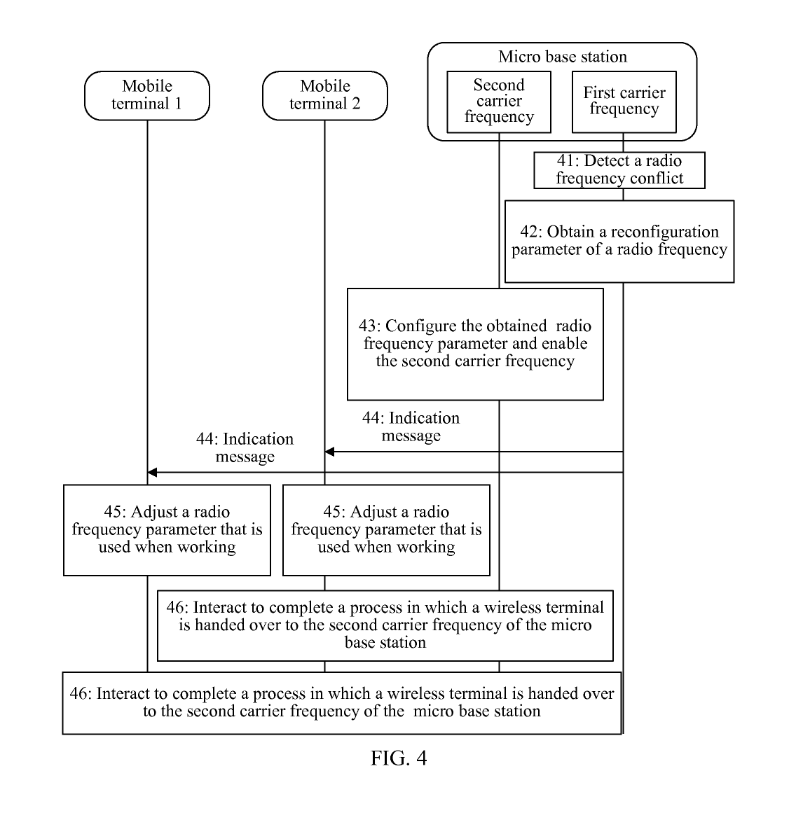

Referring to FIG. 4, FIG. 4 is a diagram of message interaction in a process of solving a radio frequency conflict of a micro base station in this embodiment. The message interaction includes the following steps:

41: A micro base station that uses a first carrier frequency detects a radio frequency conflict.

42: The micro base station obtains a reconfiguration parameter of a radio frequency by using the first carrier frequency.

43: The micro base station configures the obtained reconfiguration parameter of the radio frequency on a second carrier frequency and enables the second carrier frequency.

44: The micro base station sends an indication message by using the first carrier frequency to a wireless terminal that is served, where the indication message carries an identifier of the micro base station and a radio frequency parameter that is to be used by the second carrier frequency.

The indication message may be a handover request message or a broadcast message, and the radio frequency parameter includes a preamble sequence and a channel parameter.

45: The wireless terminal adjusts, according to the indication message, a radio frequency parameter that is used when the wireless terminal works.

46: The micro base station interacts with the wireless terminal to complete a process in which the wireless terminal is handed over to the second carrier frequency of the micro base station.

By adopting the micro base station reconfiguration method provided in this embodiment, after obtaining the reconfiguration parameter of the radio frequency, the micro base station with the dual-carrier-frequency function first configures the reconfiguration parameter of the radio frequency on the second carrier frequency and enables the second carrier frequency, where the reconfiguration parameter of the radio frequency are obtained by using the first carrier frequency, and then sends the indication message by using the first carrier frequency to the wireless terminal that is served to instruct the wireless terminal that is currently served to initiate a handover to the second carrier frequency of the micro base station itself. Through such a process, the micro base station completes reconfiguration of the radio frequency parameter, so that a problem of a radio frequency conflict is solved. At the same time, there is only a delay of no more than one base-station-to-base-station handover for a service on the wireless terminal that is currently served, thereby ensuring continuity of a current service.

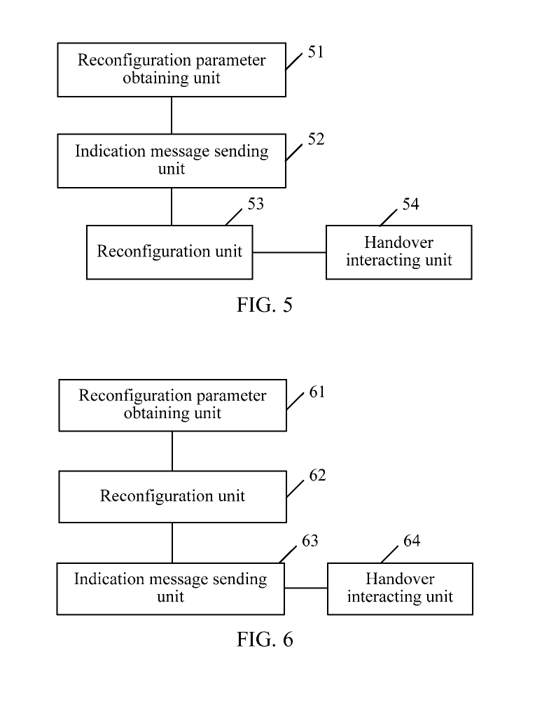

Based on the foregoing two micro base station reconfiguration method embodiments of the present invention, referring to FIG. 5 and FIG. 6, the present invention accordingly provides embodiments of two types of micro base stations.

FIG. 5 is a composition diagram of functional units of a micro base station that is corresponding to a first micro base station reconfiguration method embodiment. Referring to FIG. 5, an embodiment of the present invention provides a micro base station, which includes:

a reconfiguration parameter obtaining unit 51, configured to obtain a reconfiguration parameter of a radio frequency;

an indication message sending unit 52, configured to send an indication message to a wireless terminal that is served, where the indication message carries an identifier of the micro base station and a radio frequency parameter that is to be used after reconfiguration, or, the indication message carries an identifier of a neighboring base station of the micro base station and a radio frequency parameter that is used by the neighboring base station; and

a reconfiguration unit 53, configured to perform radio frequency reconfiguration according to the reconfiguration parameter of the radio frequency.

Optionally, after the reconfiguration unit 53 completes the radio frequency reconfiguration according to the reconfiguration parameter of the radio frequency, the micro base station may further include:

a handover interacting unit 54, configured to interact with the wireless terminal that is served to complete a process in which the wireless terminal is handed over to the micro base station, or to the neighboring base station of the micro base station.

FIG. 6 is a composition diagram of functional units of a micro base station that is corresponding to a second micro base station reconfiguration method embodiment. Referring to FIG. 6, an embodiment of the present invention provides another micro base station, which includes:

a reconfiguration parameter obtaining unit 61, configured to obtain a reconfiguration parameter of a radio frequency by using a first carrier frequency;

a reconfiguration unit 62, configured to perform configuration on the reconfiguration parameter of the radio frequency on a second carrier frequency and enable the second carrier frequency; and

an indication message sending unit 63, configured to send an indication message by using the first carrier frequency to a wireless terminal that is served, where the indication message carries an identifier of the micro base station and a radio frequency parameter that is to be used by the second carrier frequency.

Optionally, after the indication message sending unit 63 sends the indication message by using the first carrier frequency to the wireless terminal that is served, the micro base station may further include:

a handover interacting unit 64, configured to interact with the wireless terminal that is served to complete a process in which the wireless terminal is handed over to the second carrier frequency of the micro base station.

It should be noted that, the micro base station in the second micro base station embodiment of the present invention is a micro base station with a dual-carrier-frequency function, and provides a communication service for a connected wireless terminal by using a single-carrier-frequency mode when the micro base station works normally.

Finally, it should be noted that, persons of ordinary skill in the art may understand that, all or a part of the processes in the method in the foregoing embodiments may be accomplished by a computer program instructing relevant hardware. The program may be stored in a computer readable storage medium. When the program is performed, the processes of each method in the foregoing embodiments are included. The storage medium may be a magnetic disk, an optical disk, a read-only memory (Read-Only Memory, ROM), or a random access memory (Random Access Memory, RAM), and so on.

Each functional unit in the embodiments of the present invention may be integrated in one processing module or may exist as a separate physical unit, or two or more units may be integrated in one module. The foregoing integrated module may be implemented in the form of hardware, and may also be implemented in the form of a software functional module. If the integrated module is implemented in the form of a software functional module and is sold or used as an independent product, the integrated module may also be stored in a computer readable storage medium. The foregoing-mentioned storage medium may be a read-only memory, a magnetic disk or an optical disk, and so on.

The foregoing specific embodiments are not intended to limit the present invention. For persons of ordinary skill in the art, any modification, equivalent replacement, and improvement made without departing from the principle of the present invention shall all fall within the protection scope of the present invention.

1. A method for reconfiguring a micro base station, comprising:
obtaining a reconfiguration parameter of a radio frequency;
sending an indication message to a wireless terminal that is served, wherein the indication message carries one of the following information: (a) an identifier of the micro base station and a radio frequency parameter that is to be used after reconfiguration, and (b) an identifier of a neighboring base station of the micro base station and a radio frequency parameter that is used by the neighboring base station; and
performing radio frequency reconfiguration according to the reconfiguration parameter of the radio frequency.

2. The method according to claim 1, wherein obtaining the reconfiguration parameter of the radio frequency comprises one of the following steps:
generating and sending, by the micro base station, a request to a management functional entity for obtaining the reconfiguration parameter when detecting a radio frequency conflict;
determining, by the micro base station, the reconfiguration parameter according to its peripheral wireless environment when the micro base station detects the radio frequency conflict; and
receiving, by the micro base station, the reconfiguration parameter that is actively delivered by the management functional entity to the micro base station.

3. The method according to claim 1, wherein the indication message is a handover request message or a broadcast message.

4. The method according to claim 1, wherein the radio frequency parameter comprises a preamble sequence and a channel parameter.

5. The method according to claim 1, wherein after performing the radio frequency reconfiguration according to the reconfiguration parameter of the radio frequency, the method further comprises:
interacting with the wireless terminal that is served to complete a process in which the wireless terminal is handed over to the micro base station or to the neighboring base station of the micro base station.

6. A method for reconfiguring a micro base station, comprising:
obtaining a reconfiguration parameter of a radio frequency by using a first carrier frequency;
configuring the reconfiguration parameter on a second carrier frequency and enabling the second carrier frequency; and
sending an indication message by using the first carrier frequency to a wireless terminal that is served, wherein the indication message carries an identifier of the micro base station and a radio frequency parameter that is to be used by the second carrier frequency.

7. The method according to claim 6, wherein obtaining the reconfiguration parameter of the radio frequency by using the first carrier frequency comprises one of the following steps:
generating and sending, by the micro base station, a request to a management functional entity for obtaining the reconfiguration parameter when detecting the radio frequency conflict;
determining, by the micro base station, the reconfiguration parameter according to its peripheral wireless environment when the micro base station detects a radio frequency conflict; and
receiving, by the micro base station, the reconfiguration parameter that is actively delivered by the management functional entity to the micro base station.

8. The method according to claim 6, wherein the indication message is a handover request message or a broadcast message.

9. The method according to claim 6, wherein the radio frequency parameter comprises a preamble sequence and a channel parameter.

10. The method according to claim 6, wherein after sending the indication message by using the first carrier frequency to the wireless terminal that is served, the method further comprises:
interacting with the wireless terminal that is served to complete a process in which the wireless terminal is handed over to the second carrier frequency of the micro base station.

11. A micro base station, comprising:
a reconfiguration parameter obtaining unit, configured to obtain a reconfiguration parameter of a radio frequency;
an indication message sending unit, configured to send an indication message to a wireless terminal that is served, wherein the indication message carries one of the following information: (a) an identifier of the micro base station and a radio frequency parameter that is to be used after reconfiguration and (b), an identifier of a neighboring base station of the micro base station and a radio frequency parameter that is used by the neighboring base station; and
a reconfiguration unit, configured to perform radio frequency reconfiguration according to the reconfiguration parameter of the radio frequency.

12. The micro base station according to claim 11, wherein the micro base station further comprises:
a handover interacting unit, configured to, after performing the radio frequency reconfiguration according to the reconfiguration parameter of the radio frequency, interact with the wireless terminal that is served to complete a process in which the wireless terminal is handed over to the micro base station or to the neighboring base station of the micro base station.

13. A micro base station, comprising:
a reconfiguration parameter obtaining unit, configured to obtain a reconfiguration parameter of a radio frequency by using a first carrier frequency;
a reconfiguration unit, configured to perform configuration on the reconfiguration parameter of the radio frequency on a second carrier frequency and enable the second carrier frequency; and
an indication message sending unit, configured to send an indication message by using the first carrier frequency to a wireless terminal that is served, wherein the indication message carries an identifier of the micro base station and a radio frequency parameter that is to be used by the second carrier frequency.

14. The micro base station according to claim 13, wherein the micro base station further comprises:
a handover interacting unit, configured to, after sending the indication message by using the first carrier frequency to the wireless terminal that is served, interact with the wireless terminal that is served to complete a process in which the wireless terminal is handed over to the second carrier frequency of the micro base station.

15. The micro base station according to claim 14, wherein a dual-carrier-frequency function is set up in the micro base station, and the micro base station provides a communication service for a connected wireless terminal by using a single-carrier-frequency mode when the micro base station works normally.
